(19) United States
(12) Patent Application Publication
(10) Pub. No.: US 2011/0108365 A1
(43) Pub. Date: May 12, 2011

(54) EVACUATION SUPPORTING SYSTEM

(75) Inventors: Shiro Hikita, Tokyo (JP); Kiyoji Kawai, Tokyo (JP); Masahiko Konishi, Tokyo (JP); Masafumi Iwata, Tokyo (JP)

(73) Assignee: MITSUBISHI ELECTRIC CORPORATION, Tokyo (JP)

(21) Appl. No.: 13/003,313

(22) PCT Filed: Aug. 27, 2008
(86) PCT No.: PCT/JP08/65284

§ 371 Date: Jan. 10, 2011

(51) Int. Cl. B66B 1/28; B66B 3/00

(52) U.S. Cl. 187/247; 187/391

(57) ABSTRACT

An evacuation supporting system which can provide elevators in a building for evacuation in event of a fire and can substantially reduce the burden required by the rescue at the site of the fire by providing, before the arrival of firemen at the building, the firemen with information on the evacuation condition of the weak and the condition of evacuation of those who are present in the building carried out by use of the elevators. In an ancillary room within the building, there is installed an evacuation detection device which is used by disaster preventing staff in a disaster prevention center within the building to check for persons who have escaped into the ancillary room. When a fire has been detected by a fire detector, the elevators in the building are provided for evacuation for those who are present in the building, and the input status of the evacuation detection device and the evacuation operation condition of the elevator are transmitted to an external computer environment.

### TECHNICAL FIELD

The present invention relates to an evacuation supporting system for providing evacuation support to those who are present in a building provided with an elevator when a fire breaks out in the building.

### BACKGROUND ART

When a fire breaks out in a building, in general, each elevator installed in the building travels to the nearest floor and subsequent operations are then stopped. Such control is carried out mainly to prevent secondary disasters due to continued operations of the elevator. In recent years, however, fire protection partitions in buildings and other techniques have been improved and floors except the floor on which a fire broke out and floors in the vicinity of this floor have come to be less affected by the fire. For this reason, in buildings where fire preventive measures are appropriately taken, it has become possible to continue elevator operations even after the breakout of a fire except for part of the floors.

There is an evacuation supporting system described in Patent Document 1 as described below, for example, as conventional art for an evacuation supporting system suited to such buildings. In the evacuation supporting system described in Patent Document 1, an elevator evacuation operation method is prepared in such a manner that in the event of a fire in a building, the floor where the fire broke out and smoke was generated and fire protection partitions are evaded. That is, those who are present in a building can safely escape by using elevators even when a fire breaks out in the building.
Patent Document 1: Japanese Patent Laid-Open No. 2005-104630

### DISCLOSURE OF THE INVENTION

### Problems to be Solved by the Invention

In the evacuation supporting system described in Patent Document 1, those who are present in a building can escape by using elevators even after the outbreak of a fire and, therefore, it is possible to carry out evacuation more swiftly than in the case where only stairs are used.

On the other hand, when the outbreak of a fire in a building has been confirmed, the information is communicated to a fire station and firemen are dispatched from the fire station to the building which is the site of the fire. Under the present circumstances, the firemen who have arrived at the site of the fire, first go to a disaster prevention center, obtain information on the people remaining in the building from the disaster preventing staff of the disaster prevention center, and then start rescue and fire-fighting activities. Therefore, in conventional evacuation supporting systems including the evacuation supporting system described in the aforementioned Patent Document 1, firemen cannot know the condition of the building until they arrive at the site and hence a heavy burden has been imposed on firemen by the rescue of those who are present in the building, in particular, the weak vulnerable to disasters (hereinafter simply referred to also as “the weak”), such as physically-handicapped persons and wheelchair users.

The present invention has been made to solve the problem described above, and the object of the invention is to provide an evacuation supporting system which can provide elevators in a building as evacuation means in the event of a fire and can substantially reduce the burden required by the rescue at the site of the fire by providing, before the arrival of firemen at the building, the firemen with information on the evacuation condition of the weak and the condition of evacuation of those who are present in the building carried out by use of the elevators.

### Means for Solving the Problems

An evacuation supporting system according to the present invention is an evacuation supporting system for a building provided with an elevator and an ancillary room for which prescribed fire prevention measures and smoke prevention measures are taken, which comprises an evacuation detection device which is provided in the ancillary room and is used by disaster preventing staff in a disaster prevention center within the building to check for persons who have escaped into the ancillary room, a fire detector which is provided in the building and detects fires breaking out in the building, and an evacuation supporting device which provides the elevator as evacuation means for those who are present in the building when a fire has been detected by the fire detector, and transmits the input status of the evacuation detection device and the evacuation operation condition of the elevator to an external computer environment.

### Effect of the Invention

According to the present invention, it is possible to provide elevators in a building as evacuation means in the event of a fire and it is possible to substantially reduce the burden required by the rescue at the site of the fire by providing, before the arrival of firemen at the building, the firemen with information on the evacuation condition of the weak and the condition of evacuation of those who are present in the building carried out by use of the elevators.

### BRIEF OF DESCRIPTION OF THE DRAWINGS

FIG. 1 is a block diagram showing an evacuation supporting system in a first embodiment according to the present invention.

FIG. 2 is a plan view showing an essential portion of a building provided with the evacuation supporting system shown in FIG. 1.

FIG. 3 is a side view of the ancillary room shown in FIG. 2.

FIG. 4 is a flowchart showing the operation of the evacuation supporting system in the first embodiment according to the present invention.

### DESCRIPTION OF SYMBOLS

1 group controller
2 evacuation supporting device
3 camera
4 interphone
5 disaster prevention controller
6 fire detector
7 emergency broadcasting device
8 stairs
9 ancillary room
10 living space
11 passage
12 evacuation condition checking section
13 evacuation condition transmitting section
14 intercommunication section
15 evacuation operation section

### BEST MODE FOR CARRYING OUT THE INVENTION

The present invention will be described in more detail with reference to the accompanying drawings. Incidentally, in each of the drawings, like numerals refer to like or similar parts and redundant descriptions of these parts are appropriately simplified or omitted.

### First Embodiment

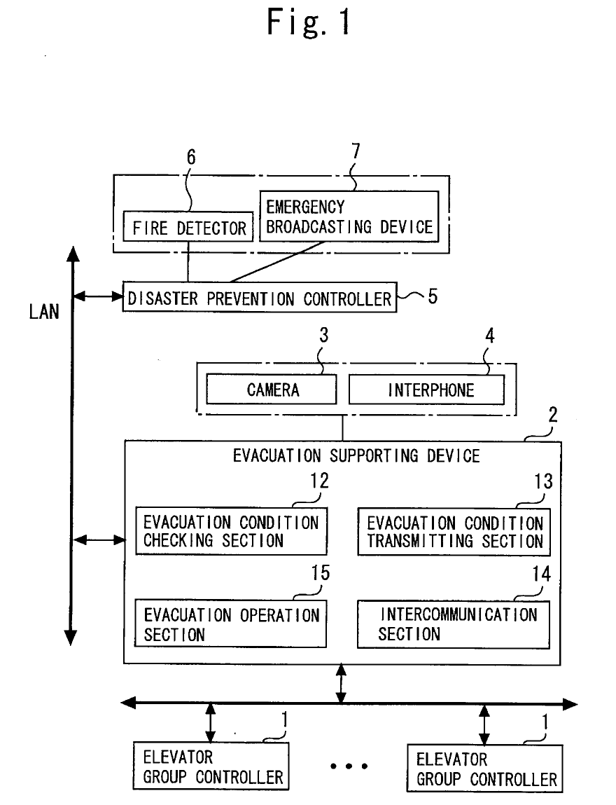

FIG. 1 is a block diagram showing an evacuation supporting system in a first embodiment according to the present invention.

In FIG. 1, reference numeral 1 denotes a group controller which controls elevator groups installed in a building. That is, the operation of each elevator in the building is controlled by the above-described group controller 1 on a group basis. Reference numeral 2 denotes an evacuation supporting device connected to each group controller 1 via a communication line (for example, a LAN in the building), and reference numerals 3 and 4 denote a camera and an interphone, respectively, which are connected to the evacuation supporting device 2.

The above-described evacuation supporting device 2 has the function of giving general operation instructions for the elevators in the event of a fire and providing the elevators as evacuation means for those who are present in the building. The evacuation supporting device 2 has also the function of providing firemen dispatched from a fire station to perform fire-fighting activities and rescue activities for those who are present in the building in the event of a fire with various kinds of information, such as the evacuation condition of the weak and the condition of evacuation of those who are present in the building carried out by use of the elevators.

Reference numeral 5 denotes a disaster prevention controller which performs the supervisory control of the whole disaster prevention equipment in the building. The disaster prevention controller 5 is connected to each piece of disaster prevention equipment in the building, for example, a fire detector 6 (including also a smoke detector) installed on each floor of the building, and an emergency broadcasting device 7. This disaster prevention controller 5 carries out announcement about evacuation guidance from the emergency broadcasting device 7, and notifies the evacuation supporting device 2 and a prescribed fire station of the information that a fire broke out (hereinafter referred to also as “fire information”) when the fire detector 6 detects the outbreak of a fire in the building.

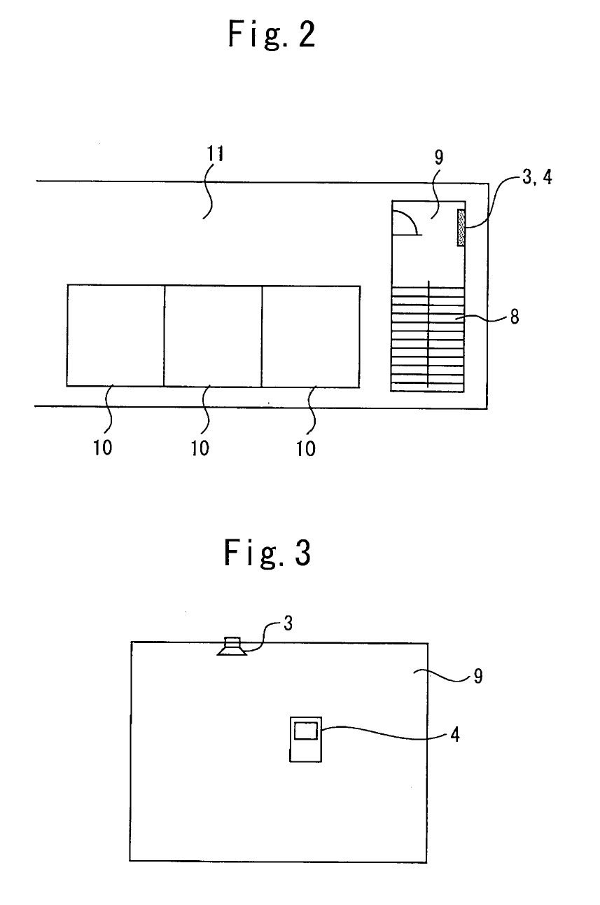

Next, on the basis of FIGS. 2 and 3, a description will be given of the concept of temporary evacuation in the event of a fire in a building. FIG. 2 is a plan view showing an essential portion of a building provided with the evacuation supporting system shown in FIG. 1, and FIG. 3 is a side view of the ancillary room shown in FIG. 2.

In general, an area called an ancillary room 9 is provided in the vicinity of stairs 8 of a building. Reference numeral 10 denotes a living space in the building, and reference numeral 11 denotes a passage leading from the living space 10 to the stairs 8 and the hall of an elevator. FIG. 2 shows the case where the ancillary room 9 communicates directly with the stairs 8 leading to the floor below and the floor above and the ancillary room 9 can be separated from the living space 10 and the passage 11. In this ancillary room 9, prescribed appropriate fire prevention measures and smoke prevention measures are taken. For this reason, the ancillary room 9 is particularly excellent as a place into which the weak vulnerable to disasters, such as physically-handicapped persons and wheelchair users who cannot take swift actions, escape temporarily in the event of a fire.

Usually, the ancillary room 9 is adjacent to the stairs 8 and, therefore, able-bodied people need not remain in the ancillary room 9 in the event of a fire and can escape by using the stairs 8.

The above-described ancillary room 9 is equipped with an evacuation detection device, and in the event of a fire, the disaster preventing staff present in the disaster prevention center within the building can ascertain by use of this evacuation detection device that the weak have escaped into the ancillary room 9. The above-described camera 3 and interphone 4 are examples of the evacuation detection device. The camera 3 is installed, for example, in the ceiling portion of the ancillary room 9, on the wall surface or the like thereof, and is configured to be able to monitor the presence or absence of persons in the ancillary room 9 within the disaster prevention center. That is, the disaster preventing staff present in the disaster prevention center can make sure of the presence or absence of persons in the ancillary room 9 from the pictures taken with the camera 3. Also the interphone 4 is installed on the wall surface or the like of the ancillary room 9. For this reason, persons in the ancillary room 9 can have conversations with the disaster preventing staff of the disaster prevention center by use of this interphone 4.

The above-described evacuation detection device is not limited to the camera 3 or the interphone 4, and any device can be used so long as it enables the disaster preventing staff present in the disaster prevention center to make sure of the persons who have escaped into the ancillary room 9 in the event of a fire. The evacuation detection device may be, for example, a device which transmits evacuation from the side of the evacuees in the ancillary room 9, such as an emergency button, or may be a device which makes sure of evacuees from the side of the disaster preventing staff in the disaster prevention center, as with the above-described camera 3.

Next, the constitution of the above-described evacuation supporting device 2 will be described concretely.

To realize the above-described function, the evacuation supporting device 2 is provided with, for example, an evacuation condition checking section 12, an evacuation condition transmitting section 13, an intercommunication section 14 and an evacuation operation section 15. Each function of the sections 12 to 15 is configured by the software on a computer, and carries out prescribed actions on the basis of the information from the disaster prevention controller 5, the evacuation detection device and each group controller 1.

Concretely, the above-described evacuation condition checking section 12 has the function of checking the evacuation condition of those who are present in the building in the event of a fire. That is, the evacuation condition checking section 12 starts the monitoring of the input status of the evacuation detection device and the monitoring of the evacuation operation condition of each elevator through the input of fire information from the disaster prevention controller 5, and gathers various kinds of information for checking the evacuation condition of those who are present in the building.

The information monitored and gathered by the evacuation condition checking section 12 includes, for example, the operating condition of elevators performing evacuation operations (information on elevators in operation), the number of persons getting in elevators on each floor and the number of persons getting off elevators at evacuation floors. In addition, information on the presence or absence of evacuees in the ancillary room 9 based on the input status of the camera 3 and the interphone 4, information on the detection of the fire detector 6 and the like are also monitored and gathered.

The evacuation condition transmitting section 13 has the function of transmitting the monitoring information by the evacuation condition checking section 12 to an external computer environment which has been registered beforehand. That is, various kinds of information gathered by the evacuation condition checking section 12, for example, the input status of the evacuation detection device and the evacuation operation condition of each elevator are transmitted from this evacuation condition transmitting section 13 to the external computer environment of a prescribed fire station and of portable terminals (for example, personal computers, cell phones and terminals dedicated to rescue) and the like possessed by prescribed firemen.

For example, mail sending to addresses which have been known beforehand (have been registered) is conceivable as a concrete method of transmission to an external computer environment. Sending and writing to prescribed URL addresses through the Internet may also be performed. In this case, if a password has been released to firemen beforehand, only the firemen can browse necessary information.

The intercommunication section 14 has the function of ensuring conversations between the operator of the interphone 4 and the disaster preventing staff of the disaster prevention center when there is an input from the interphone 4 of the ancillary room 9.

The evacuation operation section 15 has the function of giving evacuation operation instructions to each elevator group. That is, when a fire has been detected by the fire detector 6, the evacuation operation section 15 controls the evacuation operation for safely evacuating those who are present in the building to outside the building on the basis of the information on the floor where the fire has broken out from the disaster prevention controller 5 and the information from the group controller 1.

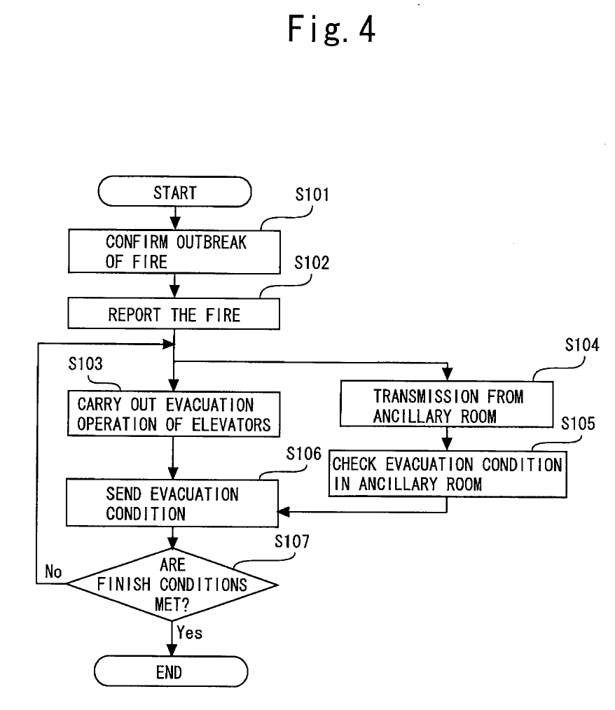

Next, on the basis of FIG. 4, a concrete description will be given of the operation of the evacuation supporting system having the above-described configuration. FIG. 4 is a flowchart showing the operation of the evacuation supporting system in the first embodiment according to the present invention.

When a fire breaking out in the building is detected by the fire detector 6 and the outbreak of the fire is confirmed by the disaster prevention controller 5 (S101), a prescribed fire station and the evacuation supporting device 2 are notified by this disaster prevention controller 5 of the information on the outbreak of the fire (S102).

Through the input of the fire information from the disaster prevention controller 5, in the evacuation supporting device 2, an evacuation operation suited to the floor on which the fire broke out and the condition of the fire is started by the evacuation operation section 15. Evacuation guidance for those who are present in the building are performed from the emergency broadcasting device 7 via the disaster prevention controller 5 (S103). Because the method disclosed in Japanese Patent Laid-Open No. 2005-104630, for example, can be adopted for the operation in this S103, a detailed description here is omitted.

Through the input of the fire information from the disaster prevention controller 5, the evacuation supporting device 2 starts the monitoring of the input status of the evacuation detection device along with the monitoring of the evacuation operation condition of elevators. Through the transmission of evacuation information by the people who have escaped into the ancillary room 9 by use of the interphone 4 or by other means from the ancillary room 9 (S104), the evacuation condition in the ancillary room 9 is checked by the evacuation condition checking section 12 (S105).

The evacuation condition transmitting section 13 transmits data concerning the evacuation condition gathered by the evacuation condition checking section 12 to an external computer environment (S106).

This transmission to an external computer environment is performed periodically and continually from immediately after the confirmation of the outbreak of the fire in S101 to the time when prescribed finish conditions meaning the finish of the evacuation rescue activities are met (S107). For example, cases A to C below are conceivable as cases where the above finish conditions are met.

A: The finish of the evacuation operation is determined by the judgment of the disaster preventing staff, firemen and the like and information to that effect is inputted.

B: The safety of elevator operations is jeopardized by the spread of the fire, the exposure to water due to fire-fighting activities and the like.

C: There are no longer persons on the rescue floor who get on the elevator to rescue people inside the building and the weak and other people in the ancillary room 9 are not present anymore, and it is determined that the evacuation of those who are present in the building has been completed.

The transition to the condition given in A above is performed by a manual input by firemen or other people. The transition to the conditions given in B and C above can be automatically determined by elevator-related equipment, such as getting-on/off passenger sensors. Incidentally, satisfaction of the above-described finish conditions is not limited to the cases given in A to C above. That is, in the case where it has become difficult to secure safety due to some condition and in the case where conditions allowing the determination that the evacuation of those who are present in the building has been completed are met, the flow of operation proceeds to “Yes” of S107 and the transmission of the evacuation condition is finished.

According to the first embodiment of the present invention, it is possible to provide the elevators in the building as evacuation means in the event of a fire. Furthermore, it is possible to provide, before the arrival of firemen at the building, the firemen with information on the evacuation condition of the weak and the condition of evacuation of those who are present in the building carried out by use of the elevators, whereby it becomes possible to substantially reduce the burden required by the rescue at the site of the fire.

That is, firemen can know the operating condition of the elevators in the building, the number of people remaining in the ancillary room 9 and the like before arriving at the building which is the site of the fire, and can start necessary work swiftly after their arrival at the site. For example, if firemen are aware that the weak are present in the ancillary room 9 before their arrival at the building, they can perform rescue activities for the weak swiftly after their arrival at the building. When they can judge that the rescue of the weak is unnecessary and that evacuation using the elevators is possible, they can dedicate themselves to fire-fighting activities swiftly after their arrival at the building. Furthermore, the firemen can refer to the information transmitted from the evacuation supporting device 2 even after their arrival at the site and hence efficient and effective work becomes possible.

Because the evacuation detection device is installed in the ancillary room 9 within the building, in the event of a fire, in the disaster prevention center within the building it is possible to check for people who have escaped into the ancillary room 9. For this reason, the disaster preventing staff can check the weak remaining in the ancillary room 9 and transmit the information to firemen who have not arrived at the site. Also this configuration makes it possible to substantially reduce the burden required by the rescue at the site of the fire.

### INDUSTRIAL APPLICABILITY

As described above, the evacuation supporting system according to the present invention can be applied to a building which is equipped with an elevator and an ancillary room for which prescribed fire prevention measures and smoke prevention measures are taken.

1. An evacuation supporting system for a building provided with an elevator and an ancillary room for which prescribed fire prevention measures and smoke prevention measures are taken, comprising:
an evacuation transmission device which is provided in the ancillary room and informs disaster preventing staff in a disaster prevention center within the building from the ancillary room that evacuees are present by use of an interphone or an emergency button;
an evacuation detection device which detects evacuees by receiving, in the disaster prevention center, information from the evacuation transmission device by use of the interphone or emergency button;
a fire detector which is provided in the building and detects fires breaking out in the building; and
an evacuation supporting device which provides the elevator as evacuation means for those who are present in the building when a fire has been detected by the fire detector, and transmits the input status of the evacuation detection device and the evacuation operation condition of the elevator to an external computer environment.

2. The evacuation supporting system according to claim 1, wherein the evacuation supporting device comprising:
an evacuation operation section which, in the case of detection of a fire by the fire detector, controls an elevator evacuation operation on the basis of information on the floor on which the fire broke out;
an evacuation condition checking section which starts monitoring the input status of the evacuation detection device and the evacuation operation condition of the elevator through the detection of the fire by the fire detector; and
an evacuation condition transmitting section which transmits the monitoring information by the evacuation condition checking section to the external computer environment which has been registered beforehand.

3. The evacuation supporting system according to claim 2, wherein the evacuation condition transmitting section periodically transmits the monitoring information by the evacuation condition checking section to the external computer environment until prescribed finish conditions are met after the detection of the fire by the fire detector.
